(19) United States
(12) Patent Application Publication
(10) Pub. No.: US 2026/0077550 A1
(43) Pub. Date: Mar. 19, 2026

(54) SYSTEM AND PROCESS FOR CREATING A THREE-DIMENSIONAL PART OR ARTICLE BY BLOW MOLDING

(71) Applicant: Pelican Intl inc., Laval (CA)

(72) Inventors: Claude THIBODEAU, Lery (CA); Steve JALBERT, Montreal (CA); Isabelle DUBREUIL, Repentigny (CA)

(73) Assignee: Pelican Intl inc., Laval (CA)

(21) Appl. No.: 19/326,457

(22) Filed: Sep. 11, 2025

Related U.S. Application Data
(60) Provisional application No. 63/694,318, filed on Sep. 13, 2024.

(51) Int. Cl. B29C 49/04; B29C 49/00; B29C 49/22; B29K 105/00; B29L 31/00; B29L 31/30

(52) U.S. Cl. CPC B29C 49/04102; B29C 49/041; B29C 49/04104; B29C 49/071; B29C 49/22; B29K 2105/0088; B29K 2995/002; B29L 2031/3067; B29L 2031/712

(57) ABSTRACT

A system for blow-molding a three-dimensional part or article. The system comprises at least one regrind extruder system and at least one color extruder system, a forming system for forming a blank from the viscous mixtures released by the extruder systems and a blow mold configured to receive the blank. The blank has a layered configuration characterized by a number of layers across a cross-section of the blank. Each one of the layers is formed by one of the viscous mixtures released by the extruder systems. The blank is inflated inside the blow mold to form the three-dimensional part or article. The three-dimensional part or article retains the layered structure of the blank.

This application claims priority from U.S. Provisional Application No. 63/694,318 filed on Sep. 13, 2024, “SYSTEM AND PROCESS FOR CREATING A THREE-DIMENSIONAL PART OR ARTICLE BY BLOW MOLDING”, the content of each being hereby incorporated by reference in its entirety.

The present disclosure relates generally to the field of blow molding systems and processes and three-dimensional parts or articles created using such systems and processes. More specifically, the present disclosure relates to blow molding systems and processes for the manufacture of three-dimensional multi-section, multi-layer and multi-material parts or articles.

### TECHNICAL FIELD

### Background of the Art

Extrusion processes are commonly used in a variety of different industries, and with a multitude of different type and grades of material, for forming and shaping these materials into articles.

Extruded products, whether plastic, metal or some other material, are often uniform in composition. In some cases, the extruded products are formed of several layers of material, including one or more visible, outer layers and one or more hidden, inner layers, where these layers may differ in composition.

In today's competitive market place, it is important for companies to provide products that take advantage of recycled materials. For example, recycled materials such as recycled plastics may readily be used in extrusion processes, however the articles or portions of the articles produced using such recycled materials will typically not exhibit the same color, processability and/or mechanical properties as articles or portions of articles produced using virgin (i.e., non-recycled) materials. As such, the location, composition and thickness of recycled materials within an extruded article (for example, the location of a layer of recycled material) should be controlled to ensure the article exhibits the desired physical and/or mechanical properties.

In light of the foregoing, there remains a need to provide blow molding systems and processes capable of addressing at least some of the shortcomings discussed above.

### SUMMARY

In accordance with a broad aspect of the present technology, there is provided a system for blow-molding a three-dimensional article, comprising at least one regrind extruder system, each one of the at least one regrind extruder system being configured to release a regrind viscous mixture, at least one color extruder system, each one of the at least one color extruder system being configured to release a color viscous mixture, a forming system for forming a blank from the at least one regrind viscous mixture and the at least one color viscous mixture, the blank having a layered configuration characterized by a number of layers across a cross-section of the blank, the blank comprising at least two layers, wherein each one of the at least two layers of the blank is formed by one of the at least one regrind viscous mixture and the at least one color viscous mixture, and a blow mold configured to receive the blank. The blank is inflated inside the blow mold to form the three-dimensional article.

In one or more embodiments of the system for blow-molding a three-dimensional article, the forming system comprises a die.

In one or more embodiments of the system for blow-molding a three-dimensional article, the die is configured to extrude the blank continuously.

In one or more embodiments of the system for blow-molding a three-dimensional article, the forming system comprises an accumulator and a die.

In one or more embodiments of the system for blow-molding a three-dimensional article, the accumulator and the die are configured to extrude the blank intermittently.

In one or more embodiments of the system for blow-molding a three-dimensional article, the blank is a parison.

In one or more embodiments of the system for blow-molding a three-dimensional article, the forming system comprises a preform mold.

In one or more embodiments of the system for blow-molding a three-dimensional article, the blank is a preform.

In one or more embodiments of the system for blow-molding a three-dimensional article, the blank comprises at least two layers.

In one or more embodiments of the system for blow-molding a three-dimensional article, the blank comprises three layers.

In one or more embodiments of the system for blow-molding a three-dimensional article, the layered configuration of the blank is further characterized by a number of portions of the blank across a circumference of the blank.

In one or more embodiments of the system for blow-molding a three-dimensional article, the blank comprises at least two portions.

In one or more embodiments of the system for blow-molding a three-dimensional article, the blank comprises at least three portions.

In one or more embodiments of the system for blow-molding a three-dimensional article, each one of the portions of the blank comprises at least two layers.

In one or more embodiments of the system for blow-molding a three-dimensional article, the layered configuration of the blank is further characterized by a thickness of each one of the layers across a cross-section of the blank.

In one or more embodiments of the system for blow-molding a three-dimensional article, all the layers of the blank have the same thickness.

In one or more embodiments of the system for blow-molding a three-dimensional article, at least one of the layers of the blank has a thickness different from remaining ones of the layers of the blank.

In one or more embodiments of the system for blow-molding a three-dimensional article, each one of the at least one regrind extruder system and each one of the at least one color extruder system comprises a blender and an extruder.

In one or more embodiments of the system for blow-molding a three-dimensional article, the extruder is configured to mix and heat a feedstock.

In one or more embodiments of the system for blow-molding a three-dimensional article, the feedstock comprises a base resin.

In one or more embodiments of the system for blow-molding a three-dimensional article, the feedstock comprises a color masterbatch.

In one or more embodiments of the system for blow-molding a three-dimensional article, the color masterbatch is one of an organic masterbatch, an inorganic masterbatch, a pearlescent masterbatch, a wood effect masterbatch, a marble masterbatch, a glitter masterbatch, a fluorescent masterbatch, a matte masterbatch, a fiber masterbatch, a stone masterbatch or a translucent masterbatch.

In one or more embodiments of the system for blow-molding a three-dimensional article, the feedstock comprises at least one additive.

In one or more embodiments of the system for blow-molding a three-dimensional article, the at least one additive is a processing aid.

In one or more embodiments of the system for blow-molding a three-dimensional article, the at least one additive is a UV protection masterbatch.

In one or more embodiments of the system for blow-molding a three-dimensional article, the feedstock comprises blow molded trimmings.

In one or more embodiments of the system for blow-molding a three-dimensional article, the at least one regrind viscous mixture and the at least one color viscous mixture are plastic mixtures.

In one or more embodiments of the system for blow-molding a three-dimensional article, the plastic mixtures are thermoplastic mixtures.

In one or more embodiments of the system for blow-molding a three-dimensional article, the thermoplastic mixtures comprise one of low-density polyethylene (LDPE) mixtures, high-density polyethylene (HDPE) mixtures, polyethylene terephthalate (PET) mixtures, acrylonitrile butadiene styrene (ABS) mixtures, polystyrene mixtures, polypropylene (PP) mixtures, acetate mixtures, butyrate mixtures, nylon mixtures, polyphenylene sulfide mixtures, acetal mixtures, polycarbonate mixtures, thermoplastic rubber mixtures or polyester mixtures.

In one or more embodiments of the system for blow-molding a three-dimensional article, at least one of the regrind viscous mixtures and the color viscous mixtures are foamed mixtures.

In one or more embodiments of the system for blow-molding a three-dimensional article, the system further comprises a feedblock configured for releasing a viscous layered stream of the at least one regrind viscous mixture and the at least one color viscous mixture towards the forming system.

In one or more embodiments of the system for blow-molding a three-dimensional article, the three-dimensional article is a kayak.

In accordance with a broad aspect of the present technology, there is provided a system for blow-molding a three-dimensional article, comprising two regrind extruder systems, each one of the two regrind extruder systems being configured to release a regrind viscous mixture, four color extruder systems, each one of the four color extruder systems being configured to release a color viscous mixture, a die for forming a parison from the two regrind viscous mixtures and the four color viscous mixtures, the parison comprising a first portion and a second portion across a circumference of the parison, wherein each one of the first and the second portions of the parison has a 3-layer configuration across the cross-sectional profile, wherein each one of the layers of the first and the second portions is formed by one of the two regrind viscous mixtures and the four color viscous mixtures, and a blow mold configured to receive the parison. The parison is inflated inside the blow mold to form the three-dimensional article.

In one or more embodiments of the system for blow-molding a three-dimensional article, the first portion comprises an inner layer, an intermediate layer and an outer layer.

In one or more embodiments of the system for blow-molding a three-dimensional article, a weight fraction of the inner layer of the first portion in the first portion is at least about 40%.

In one or more embodiments of the system for blow-molding a three-dimensional article, a weight fraction of the inner layer of the first portion in the first portion is at least about 50%.

In one or more embodiments of the system for blow-molding a three-dimensional article, a weight fraction of the inner layer of the first portion in the first portion is at least about 60%.

In one or more embodiments of the system for blow-molding a three-dimensional article, a weight fraction of the outer layer and the intermediate layer of the first portion in the first portion is at least about 20%.

In one or more embodiments of the system for blow-molding a three-dimensional article, a weight fraction of the outer layer and the intermediate layer of the first portion in the first portion is at least about 25%.

In one or more embodiments of the system for blow-molding a three-dimensional article, a volume fraction of the inner layer of the first portion in the first portion is at least about 40%.

In one or more embodiments of the system for blow-molding a three-dimensional article, a volume fraction of the inner layer of the first portion in the first portion is at least about 50%.

In one or more embodiments of the system for blow-molding a three-dimensional article, a volume fraction of the inner layer of the first portion in the first portion is at least about 60%.

In one or more embodiments of the system for blow-molding a three-dimensional article, a volume fraction of the outer layer and the intermediate layer of the first portion in the first portion is at least about 20%.

In one or more embodiments of the system for blow-molding a three-dimensional article, a volume fraction of the outer layer and the intermediate layer of the first portion in the first portion is at least about 25%.

In one or more embodiments of the system for blow-molding a three-dimensional article, the second portion comprises an inner layer, a intermediate layer and an outer layer.

In one or more embodiments of the system for blow-molding a three-dimensional article, a weight fraction of the intermediate layer of the second portion in the second portion is at least about 40%.

In one or more embodiments of the system for blow-molding a three-dimensional article, a weight fraction of the intermediate layer of the second portion in the second portion is at least about 50%.

In one or more embodiments of the system for blow-molding a three-dimensional article, a weight fraction of the intermediate layer of the second portion in the second portion is at least about 60%.

In one or more embodiments of the system for blow-molding a three-dimensional article, a weight fraction of the outer layer and the inner layer of the second portion in the second portion is at least about 20%.

In one or more embodiments of the system for blow-molding a three-dimensional article, a weight fraction of the outer layer and the inner layer of the second portion in the second portion is at least about 25%.

In one or more embodiments of the system for blow-molding a three-dimensional article, a volume fraction of the intermediate layer of the second portion in the second portion is at least about 40%.

In one or more embodiments of the system for blow-molding a three-dimensional article, a volume fraction of the intermediate layer of the second portion in the second portion is at least about 50%.

In one or more embodiments of the system for blow-molding a three-dimensional article, a volume fraction of the intermediate layer of the second portion in the second portion is at least about 60%.

In one or more embodiments of the system for blow-molding a three-dimensional article, a volume fraction of the outer layer and the inner layer of the second portion in the second portion is at least about 20%.

In one or more embodiments of the system for blow-molding a three-dimensional article, a volume fraction of the outer layer and the inner layer of the second portion in the second portion is at least about 25%.

In one or more embodiments of the system for blow-molding a three-dimensional article, each one of the at least one regrind extruder system and each one of the at least one color extruder system comprises a blender and an extruder.

In one or more embodiments of the system for blow-molding a three-dimensional article, the extruder is configured to mix and heat a feedstock.

In one or more embodiments of the system for blow-molding a three-dimensional article, the feedstock comprises a base resin.

In one or more embodiments of the system for blow-molding a three-dimensional article, the feedstock comprises a color masterbatch.

In one or more embodiments of the system for blow-molding a three-dimensional article, the color masterbatch is one of an organic masterbatch, an inorganic masterbatch, a pearlescent masterbatch, a wood effect masterbatch, a marble masterbatch, a glitter masterbatch, a fluorescent masterbatch, a matte masterbatch, a fiber masterbatch, a stone masterbatch or a translucent masterbatch.

In one or more embodiments of the system for blow-molding a three-dimensional article, the feedstock comprises at least one additive.

In one or more embodiments of the system for blow-molding a three-dimensional article, the at least one additive is a processing aid.

In one or more embodiments of the system for blow-molding a three-dimensional article, the at least one additive is a UV protection masterbatch.

In one or more embodiments of the system for blow-molding a three-dimensional article, the feedstock comprises blow molded trimmings.

In one or more embodiments of the system for blow-molding a three-dimensional article, the at least one regrind viscous mixture and the at least one color viscous mixture are plastic mixtures.

In one or more embodiments of the system for blow-molding a three-dimensional article, the plastic mixtures are thermoplastic mixtures.

In one or more embodiments of the system for blow-molding a three-dimensional article, the thermoplastic mixtures comprise one of low-density polyethylene (LDPE) mixtures, high-density polyethylene (HDPE) mixtures, polyethylene terephthalate (PET) mixtures, acrylonitrile butadiene styrene (ABS) mixtures, polystyrene mixtures, polypropylene (PP) mixtures, acetate mixtures, butyrate mixtures, nylon mixtures, polyphenylene sulfide mixtures, acetal mixtures, polycarbonate mixtures, thermoplastic rubber mixtures or polyester mixtures.

In one or more embodiments of the system for blow-molding a three-dimensional article, at least one of the regrind viscous mixtures and the color viscous mixtures are foamed mixtures.

In one or more embodiments of the system for blow-molding a three-dimensional article, the system further comprises a feedblock configured for releasing a viscous layered stream of the at least one regrind viscous mixture and the at least one color viscous mixture towards the forming system.

In one or more embodiments of the system for blow-molding a three-dimensional article, the first portion is a top portion and the second portion is a bottom portion.

In one or more embodiments of the system for blow-molding a three-dimensional article, the three-dimensional article is a kayak.

In one or more embodiments of the system for blow-molding a three-dimensional article, the first portion is a deck portion and the second portion is a hull portion.

### BRIEF DESCRIPTION OF THE DRAWINGS

Having thus generally described the nature of the invention, reference will now be made to the accompanying drawings, showing by way of illustration example embodiments thereof and in which:

FIG. 1A shows a system for manufacturing a three-dimensional part or article by extrusion blow molding and comprising one or more regrind extruder systems and one or more color extruder systems, in accordance with a non-limiting embodiment;

FIG. 1B shows a system for manufacturing a three-dimensional part or article by injection blow molding and comprising one or more regrind extruder systems and one or more color extruder systems, in accordance with a non-limiting embodiment;

FIG. 2 shows the regrind extruder system of FIGS. 1A-1B, in accordance with a non-limiting embodiment;

FIG. 3 shows the color extruder system of FIGS. 1A-1B, in accordance with a non-limiting embodiment;

FIG. 4 shows a process for manufacturing a three-dimensional part or article by forming a parison and using the system of FIG. 1A, in accordance with a non-limiting embodiment;

FIG. 5 shows a schematic representation of an implementation of the process of FIG. 4, in accordance with a non-limiting embodiment;

FIG. 6 shows a process for manufacturing a three-dimensional part or article by forming a preform and using the system of FIG. 1B, in accordance with a non-limiting embodiment;

FIG. 7A shows a cross-section of a multilayered parison produced using the process of FIG. 4, in accordance with a non-limiting embodiment;

FIG. 7B shows a cross-section of a multilayered parison produced using the process of FIG. 4, in accordance with another non-limiting embodiment;

FIG. 7C shows a cross-section of a multilayered parison produced using the process of FIG. 4, in accordance with a further non-limiting embodiment;

FIG. 7D shows a cross-section of a multilayered parison produced using the process of FIG. 4, in accordance with a further non-limiting embodiment;

FIG. 7E shows a cross-section of a multilayered parison produced using the process of FIG. 4, in accordance with a further non-limiting embodiment;

FIG. 7F shows a cross-section of a multilayered parison produced using the process of FIG. 4, in accordance with a further non-limiting embodiment;

FIG. 8 shows a schematic cross-section of two multilayered portions of a three-dimensional article blow molded from the parison of FIG. 7C, in accordance with a non-limiting embodiment; and

FIG. 9 shows a top view of the system of FIG. 1A used to produce a three-dimensional part or article with three distinct top layers and three distinct bottom layers and comprising 2 regrind extruder systems of FIGS. 2 and 4 color extruder systems of FIG. 3.

### DETAILED DESCRIPTION

The present disclosure is directed to systems and processes for creating a three-dimensional part or article by blow molding, as well as the three-dimensional parts or articles created by such systems and processes. More specifically, the present disclosure is directed to systems and processes engineered to create colored multi-layer, multi-section and multi-material three-dimensional parts or articles by blow molding, as well as the colored multi-layer, multi-section and multi-material three-dimensional parts or articles created by such systems and processes.

Within the context of the present disclosure, the term “blow molding” is understood to refer to any forming process of a hollow object by inflating or blowing a molten tube (also referred to as a parison, as further described below) or a preform in the shape of a mold cavity. Blow molding processes comprise injection blow molding (IBM) processes, in which the material is injected into a preform mold cavity and then blow molded, and extrusion blow molding (EBM) processes, in which the material is extruded to make a parison and then blow molded. EBM processes include continuous and intermittent processes. Within the context of the present disclosure, the term “extrusion” refers to any process in which a material is forced to flow through a die in order to confer a shape to the material. It will be appreciated that all variants of IBM and EBM processes (such as injection stretch blow molding process ISBM) are also intended to fall within the scope of the present disclosure.

In the following embodiments, the systems and processes will be described for use in the creation of blow molded parts or articles made of at least one plastic material. However, it is to be appreciated that the present disclosure is not limited to any particular type of material. Rather, the concepts described therein may be applied to different types and grades of material suitable to be used in blow molding processes, as well as to different types of blow molding processes (i.e., IBM and EBM processes). It will also be readily appreciated that the materials that can be used with the IBM and EBM processes described therein can be foamed using a chemical foaming agent or using a physical foaming process to enable, for example, weight reduction, increased physical tolerance and/or stiffness, reduced material usage and/or cycle time.

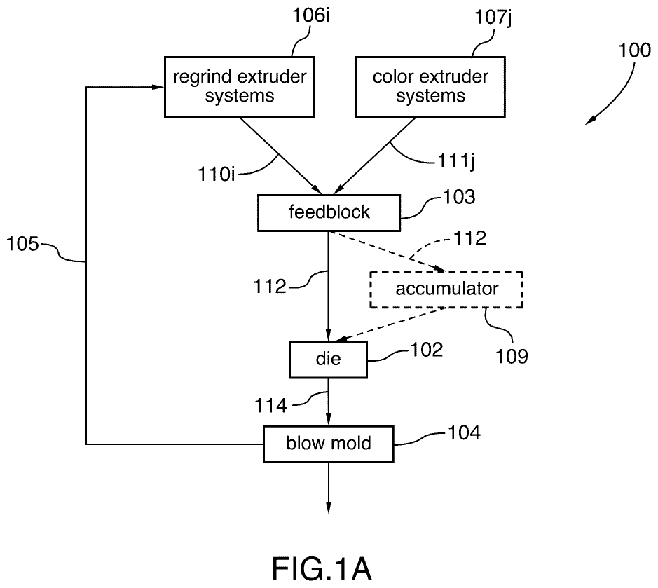

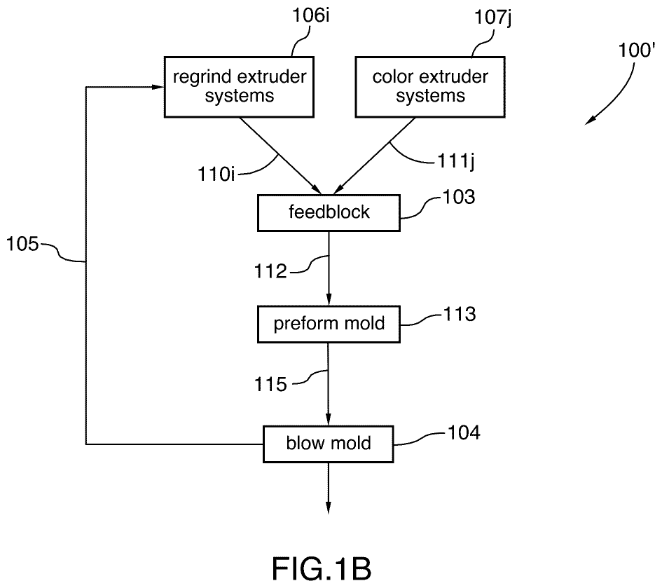

FIG. 1A shows a non-limiting embodiment of a system 100 for manufacturing a three-dimensional part or article using an extrusion blow molding process, as further described below. The system 100 shown is formed of several components and comprises a die 102, a feedblock 103, a blow mold 104, one or more regrind extruder systems 106; (where i is the number of regrind extruder systems), one or more color extruder systems 107ⱼ (where j is the number of color extruder systems) and optionally an accumulator 109. As further described below, any suitable number of regrind extruder systems 106; and color extruder systems 107ⱼ may be used to produce the three-dimensional part or article.

In this embodiment, each regrind extruder system 106; releases a flow of a viscous plastic mixture 110; towards the feedblock 103. Similarly, each color extruder system 107ⱼ also releases a flow of a (color) viscous plastic mixture 111ⱼ towards the feedblock 103, which in turns releases a viscous layered stream 112 towards the die 102. The die 102 then releases a parison 114 in the blow mold 104. As a result of the operation of the blow mold 104, a three-dimensional part or article is formed along with blow molded trimmings 105 which may be used as feedstock for the regrind extruder system 106ᵢ, as further described below.

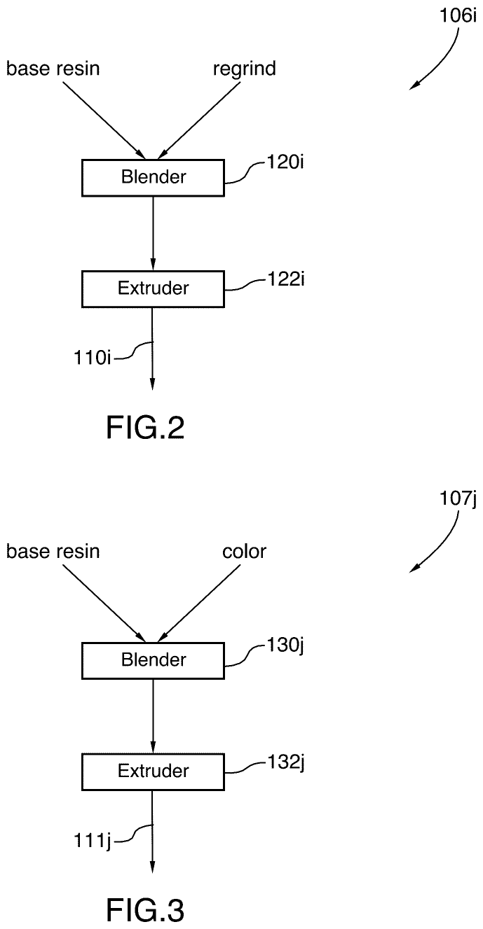

FIG. 2 shows a non-limiting embodiment of the regrind extruder system 106ᵢ, each one of the regrind extruder systems 106; comprising a blender 120; and an extruder 122ᵢ. The blender 120; is configured to mix a base resin and a regrind. Within the context of the present disclosure, the term “base resin” is understood to refer to any suitable resin, including a plastic resin, for example in the form of plastic granules (also referred to as virgin plastic granules), and the term “regrind” is understood to refer to any suitable recycled resin, for example the blow molded trimmings 105 which are produced as a result of the operation of the system 100 (or the system 100′) or another stream of recycled plastic granules. Along with the base resin and the regrind, a variety of additives may also be mixed in the blender 120; which can include, for example, UV protection masterbatches and processing aids.

The extruder 122; is operative to mix and heat the virgin and recycled plastic granules. The virgin and recycled plastic granules are heated in the extruder 122; to a predetermined temperature, sufficient to cause melting of the granules, for producing a substantially homogeneous, viscous plastic mixture 110; (also referred to as regrind viscous plastic mixture 110ᵢ) which is eventually released by the extruder 122; and caused to flow towards the feedblock 103.

In some non-limiting examples, the system 100 comprises at least 2 regrind extruder systems 106ᵢ, in some cases at least 3 regrind extruder systems 106ᵢ, in some cases at least 4 regrind extruder systems 106; and in some cases even more, as further described below. Similarly, in some non-limiting examples, the system 100 comprises at least 2 extruders 122ᵢ, in some cases at least 3 extruders 122ᵢ, in some cases at least 4 extruders 122; and in some cases even more. It will be readily appreciated that when more than one regrind viscous plastic mixture 110; are released by the regrind extruder systems 106ᵢ, the plurality of regrind viscous plastic mixtures 110; may or may not be of the same color, may or may not be made of the same plastic material and/or may or may not have the same processability or mechanical properties (e.g., in terms of the melt strength properties and stability of the parison 114), may or may not have the same combination of base resin and regrind and/or the same proportion of base resin and regrind, as further described below.

It will also be appreciated that, although the base resin is colorless, the regrind (including the blow molded trimmings 105) may or may not exhibit a color. For example, the regrind may have any color resulting from the color or colors of the source material that was reground (e.g., the regrind may be red if the source material was red, the regrind may be pink if the source material was red and white, etc.). In some non-limiting examples, the regrind may be colored in black or in white to provide some contrast with adjacent regions of the three-dimensional part or article that have a color, as further described below. In further non-limiting examples, the color and/or the opacity of the regrind may also be selected such that the color and/or the opacity of the layer or layers of the three-dimensional part or article that include the regrind contrast with the color and/or the opacity of the adjacent layers thereof. In yet further non-limiting examples, the regrind viscous plastic mixture 110ᵢ released by the regrind extruder system 106; may be dark or have a generally high opacity, or may have a generally low opacity.

FIG. 3 shows a non-limiting embodiment of the color extruder system 107ⱼ, each one of the color extruder systems 107ⱼ comprising a blender 130ⱼ and an extruder 132ⱼ. In this embodiment, the blender 130ⱼ is configured to mix a base resin and a controlled amount of a color. Along with the base resin and the color, a variety of additives (such as, but not limited to, UV protection masterbatches and processing aids) may also be mixed in the blender 130ⱼ (not shown).

Different techniques, known in the art, may be used to confer a color to the color plastic mixture 111ⱼ released by the plurality of extruders 132ⱼ. In some non-limiting examples, the color may be a color masterbatch in the form of granules that is added to and mixed with the plastic granules of the base resin in the blender 130ⱼ. Within the context of the present disclosure, the term “color masterbatch” is understood to refer to any suitable concentrated mixture of pigment and additives in a carrier matrix, including, but not limited to, the following types of masterbatches: conventional organic or inorganic solid colors, pearlescent, wood effect, marble, glitter, fluorescent, matte, fiber, stone and translucent. In other non-limiting examples, color in liquid form may be fed directly into the feed throat of the extruder 132ⱼ for mixing with the plastic granules of the base resin. In yet further non-limiting examples (not shown in FIG. 3), the plastic granules of the base resin can themselves be pre-colored such that it is not necessary to add a color to the base resin.

The extruder 132ⱼ is operative to mix and heat the virgin plastic granules (i.e., the base resin) and the color. The virgin plastic granules are heated in the extruder 132ⱼ to a predetermined temperature, sufficient to cause melting of the granules, for producing a substantially homogeneous, color plastic mixture 111ⱼ (the color plastic mixture 111ⱼ having the same color as the color mixed with the base resin in the blender 130ⱼ) which is eventually released by the extruder 132ⱼ and caused to flow towards the feedblock 103.

In some non-limiting examples, the system 100 comprises at least 2 color extruder systems 107ⱼ, in some cases at least 3 color extruder systems 107ⱼ, in some cases at least 4 color extruder systems 107ⱼ, in some cases at least 5 color extruder systems 107ⱼ, in some cases at least 6 color extruder systems 107ⱼ and in some cases even more. Similarly, in some non-limiting examples, the system 100 comprises at least 2 extruders 132ⱼ, in some cases at least 3 extruders 132ⱼ, in some cases at least 4 extruders 132; and in some cases even more. It will be readily appreciated that when more than one color viscous plastic mixture 111ⱼ are released by the color extruder systems 107ⱼ, the plurality of color viscous plastic mixtures 111ⱼ may or may not have the same color, may or may not be made of the same plastic material and/or have the same mechanical properties, as further described below.

As further described below, the regrind viscous plastic mixtures 110; and the color viscous plastic mixtures 111ⱼ may each be used to define a distinct layer in a parison and, accordingly, to define a distinct layer in a three-dimensional part or article produced therefrom.

Examples of the different types of plastics (specifically, thermoplastics) that can be blow molded using the system 100 (i.e., that can be used by the one or more regrind extruder systems 106; and by the one or more color extruder systems 107ⱼ) include, but are not limited to, low-density polyethylene (LDPE), high-density polyethylene (HDPE), polyethylene terephthalate (PET), acrylonitrile butadiene styrene (ABS), polystyrene, polypropylene (PP), acetates, butyrates, nylons, polyphenylene sulfides, acetals, polycarbonates, thermoplastic rubbers and polyesters and the likes. As described above, the materials that can be used with the IBM and EBM processes described therein can be foamed using a chemical foaming agent or using a physical foaming process to enable, for example, weight reduction, increased physical tolerance and/or stiffness, reduced material usage and/or cycle time.

The plurality of regrind extruder systems 106; and color extruder systems 107ⱼ are configured to melt and mix the plastic granules such that the resulting regrind viscous plastic mixtures 110; and color viscous plastic mixtures 111ⱼ released from the regrind extruder systems 106; and color extruder systems 107ⱼ, respectively, are melted and substantially homogeneous, both in temperature and in color (if applicable), upon exiting respective one of the regrind extruder systems 106ᵢ/color extruder systems 107ⱼ.

The term “melted” implies that the regrind viscous plastic mixture 110; and the color viscous plastic mixture 111ⱼ may be characterized by a viscous or semi-fluid flow. In this embodiment, the one or more regrind extruder systems 106; release the regrind viscous plastic mixture 110ᵢ at a first rate of flow. The first rate of flow may be any suitable rate of flow depending on the type of material that is being extruded, for example in some cases about 400 kg/hr, in some cases about 300 kg/hr, in some cases about 100 kg/hr, in some cases about 50 kg/hr, in some cases about 25 kg/hr, in some cases about 10 kg/hr and in some cases even less. When multiple regrind extruder systems 106ᵢ, are present, each one of the regrind extruder systems 106; may release respective one of the regrind viscous plastic mixtures 110; at a different rate of flow, or all the regrind extruder systems 106; may release respective one of the regrind viscous plastic mixtures 110; at the same (first) rate of flow.

Similarly, the one or more color extruder systems 107ⱼ release the color viscous plastic mixture 111ⱼ at a second rate of flow. The second rate of flow may or may not be the same as the first rate of flow and may be any suitable rate of flow depending on the type of material that is being extruded, for example in some cases about 400 kg/hr, in some cases about 300 kg/hr, in some cases about 100 kg/hr, in some cases about 50 kg/hr, in some cases about 25 kg/hr, in some cases about 10 kg/hr and in some cases even less. When multiple color extruder systems 107ⱼ are present, each one of the color extruder systems 107ⱼ may release respective one of the color viscous plastic mixtures 111ⱼ at a different rate of flow, or all the color extruder systems 107ⱼ may release respective one of the color viscous plastic mixtures 111ⱼ at the same (second) rate of flow.

In some non-limiting examples, the first and the second rates of flow may be identical or substantially identical. In other non-limiting examples, the first and the second rates of flow may be different.

The structure and functionality of extruders such as the extruders 122ᵢ and 132ⱼ are well known to those skilled in the art, and will not be described in further detail here.

The feedblock 103 receives the regrind viscous plastic mixtures 110; and the color viscous plastic mixtures 111ⱼ released by the regrind extruder systems 106; and the color extruder systems 107ⱼ, respectively. The feedblock 103 comprises a network of channels that distribute and position the individuals flows of regrind/color viscous plastic mixtures 110ᵢ/111ⱼ as individual layers to form the viscous layered stream 112 that is released towards the die 102. The feedblock 103 may have any suitable geometry and design (according to the number of layers of the viscous layered stream 112, which can be mono or multilayer), depending on the number of viscous plastic mixtures 110ᵢ/111ⱼ released by the regrind extruder systems 106; and the color extruder systems 107ⱼ.

The die 102, which receives the viscous layered stream 112 released by the feedblock 103, comprises a discharge port (not shown) for discharging a parison 114 towards the blow mold 104, the discharge port being in fluid communication with one or more channels and being used to impart a given cross-sectional profile to the parison 114. The die 102 may be a circular die, in which case the discharge port of the circular die may comprise one or more concentric circular ports which impart a generally circular cross-sectional profile to the parison 114 at the exit of the die 102 (i.e., the parison 114 may be in the form of a generally hollow cylinder). Any other suitable configuration of the die 102 may be possible in other non-limiting embodiments and different shapes and sizes of dies 102 may be used within the system 100.

The system 100 in which the color/regrind extruder systems 106ᵢ/107ⱼ release the viscous plastic mixtures 110ᵢ/111ⱼ towards the feedblock 103, which in turn releases the viscous layered stream 112 towards the die 102, which in turn discharges the parison 114 inside the blow mold 104, may be used to implement a continuous extrusion blow molding process. In such a process, the parison 114 is extruded continuously from the die 102 and individual sections of the parison 114 (which will be used to form the eventual three-dimensional part or article) are cut off using a suitable knife system (not shown).

The system 100 also optionally comprises an accumulator 109, in which case the system 100 may be used to implement an intermittent extrusion blow molding process. When used, the accumulator 109 receives the viscous layered stream 112 released by the feedblock 103 and accumulates the plastic mixture of the viscous layered stream 112 (i.e., the regrind viscous plastic mixtures 110ᵢ and the color viscous plastic mixtures 111ⱼ) until a rod (not shown) pushes the accumulated plastic mixture of the viscous layered stream 112 towards the die 102 at prescribed time intervals to form the parison 114. Accordingly, using the accumulator 109 the parison 114 is not extruded continuously but rather intermittently.

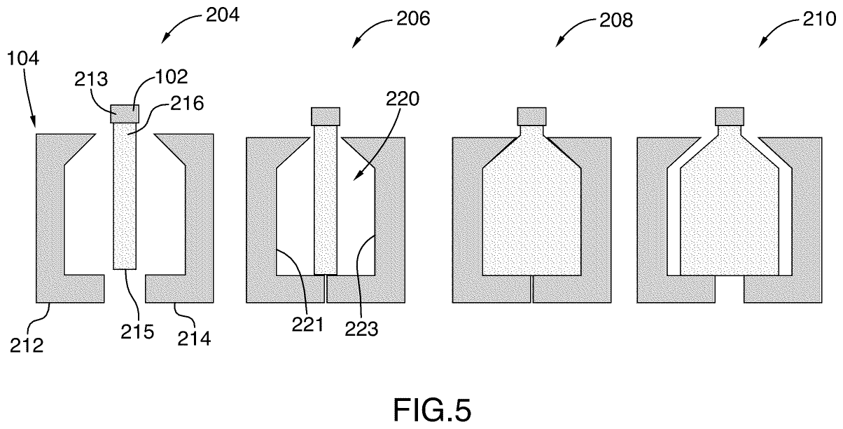

The system 100 also comprises a blow mold 104 which will be described below in greater detail in connection with FIG. 5.

It will be readily appreciated that the system 100 also comprises a number of additional components (not shown in FIG. 1A) which would be readily apparent to the person skilled in the art, including but not limited to a parison cutter system (in the case of a continuous blow molding process), a clamping unit, a blow pin, a conveyor system and the likes.

The system 100 as described above may be used to implement a blow molding process, specifically an extrusion blow molding process, to produce a three-dimensional part or article. Extrusion refers to any process in which a material (for example, a thermoplastic material), is forced to flow through a die, such as the die 102, in order to confer a shape to the material (i.e., the parison 114). Specifically, the system 100 may be used to implement a “hot” extrusion process, as the (thermoplastic) material is preliminary melted by the one or more regrind extruder systems 106ᵢ and/or the one or more color extruder systems 107ⱼ to form the regrind viscous plastic mixture 110ᵢ and the color viscous plastic mixture 111ⱼ, respectively, that are forced to flow through the die 102.

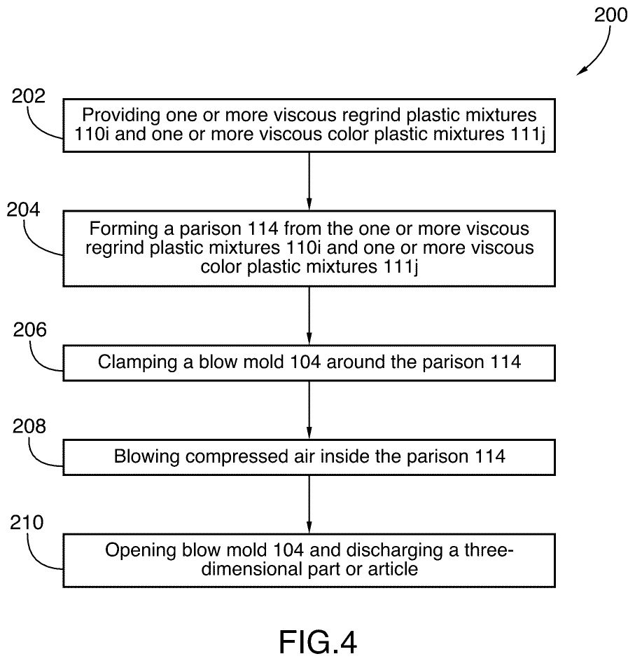

A non-limiting embodiment of an extrusion blow molding process 200 implementable by the system 100 is described below in connection with FIGS. 4 and 5.

In a first step 202, one or more regrind viscous plastic mixtures 110; and one or more color viscous plastic mixtures 111ⱼ mixtures are provided.

In a second step 204, the one or more regrind viscous plastic mixtures 110; and the one or more color viscous plastic mixtures 111ⱼ are caused to flow through the die 102 to form a parison 114 having the shape of a generally hollow cylinder, the parison 114 being opened at both ends. Within the context of the present disclosure, the term “parison” accordingly refers to the generally cylindrical, hollow mass of extruded material that exits the die 102. As shown in FIG. 5, the die 102 is generally positioned between opposing sections 212, 214 of the blow mold 104 and, at step 202, a first end 213 of the parison 114 is still secured to the die 102 (the first end 213 being referred to as a “secured” end), while a second end 215 of the parison 114 remains generally open (the second end 215 being referred to as a “hollow” end).

In a third step 206, the opposing sections 212, 214 of the blow mold 104 are clamped around the parison 114, thereby sealing the second (or hollow) end 215 of the parison 114. As shown in FIG. 5, when the opposing sections 212, 214 of the blow mold 104 are clamped, the blow mold 104 defines an inner cavity 220 circumscribed by the inner walls 221, 223 of the opposing sections 212, 214 of the blow mold 104. It will be appreciated that the inner cavity 220 has a predetermined shape, more specifically a shape generally conforming to the shape of the three-dimensional part or article to be blow molded using the process 200. It is understood that molds such as the blow mold 104 having variable shapes and/or adaptable for manufacturing parts or articles having differing shapes may also be used without departing from the teachings of the present disclosure.

In a fourth step 208, compressed air is blown from inside of the parison 114 into the inner cavity 220, for example using a blowing needle (not shown) positioned inside the die 102. As a result of the pressure build-up inside the parison 114, the parison 114 is inflated, thereby forcing the parison 114 against the inner walls 221, 223 of the opposing sections 212, 214 of the blow mold 104. At the fourth step 208, the parison 114 is accordingly shaped into a form generally conforming to the shape of the inner cavity 220 of the blow mold 104 (i.e., the shape of the three-dimensional part or article to be blow molded using the process 200).

In a fifth step 210, once the parison 114 has sufficiently cooled as a result of the introduction of compressed air and of the contact with the inner walls 221, 223 of the blow mold 104, the blow mold 104 is opened and the three-dimensional part or article is discharged from the blow mold 104. The three-dimensional part or article may then be trimmed (for example, to remove sections of the parison 114 that remained outside the inner cavity 220 of the blow mold 104 during steps 206 and 208).

In a non-limiting embodiment, the system 100 is generally configured such that the performing of the blow molding process 200 results in the formation of a parison 114 having a layered structure across a cross-section of the parison 114. Specifically, the parison 114 has a layered structure across a cross-section of the parison 114, with each one of the layers of the parison 114 being derived exclusively from one of the regrind viscous plastic mixtures 110ᵢ/the color viscous plastic mixtures 111ⱼ released by the regrind extruder systems 106ᵢ/color extruder systems 107ⱼ, respectively. In other words, the color and/or the composition and/or the mechanical properties of each one of the layers of the parison 114 may be associated with specific one of the regrind viscous plastic mixtures 110ᵢ/the color viscous plastic mixtures 111ⱼ. The system 100 therefore enables one to individually control the color and/or the composition and/or the mechanical properties of each one of the layers of the parison 114. The three-dimensional part or article that is made from the parison 114 using the system 100/the process 200 also embodies the layered structure of the parison 114. It will be readily appreciated that the parison 114 (and, accordingly, the three-dimensional part or article that is produced therefrom) may have any suitable number and/or configuration of layers, as further described below.

In one embodiment, a controller 222 (not shown) may be connected to the blow mold 104 (specifically, to one or more heating elements associated with the blow mold 104), a blower (not shown) in fluid communication with the blowing needle in the die 102 and the plurality of extruders 122ᵢ/132ⱼ, the controller 222 being configured for controlling various parameters of the extrusion blow molding process 200. In some non-limiting examples, the controller 222 may be configured to control at least one of the following parameters of the extrusion blow molding process 200:
A temperature of the parison 114: the temperature of the parison 114 influences, among others, the cooling time/rate of the parison 114 at step 206, the shape of the parison 114, its stability and thickness (along a longitudinal direction of the parison 114) as well as the “surface finish” of the three-dimensional article produced using the extrusion blow molding process 200.
A thickness of the parison 114/a thickness of individual layers of the parison 114 across a cross-section of the parison 114: the first and the second rates of flow of the regrind viscous plastic mixtures 110ᵢ and the color viscous plastic mixtures 111ⱼ that exit the one or more regrind extruder systems 106; and the one or more color extruder systems 107ⱼ, respectively, control the respective proportion of the regrind viscous plastic mixtures 110; and the color viscous plastic mixtures 111ⱼ within the viscous layered stream 112 (i.e., within individual layers of the viscous layered stream 112) that eventually exits the feedblock 103. This accordingly dictates the thickness of respective ones of the layers of the parison 114 that is eventually formed as it exits the die 102.
A blowing pressure and blowing speed of the compressed air injected via the blowing needle: the blowing pressure and speed directly affect, among others, the cooling time/rate of the parison 114 at step 206. Also, the blowing pressure inside the blow mold 104 should be sufficiently “high” to ensure that the parison 114 is inflated enough to come into contact with the inner walls 221, 223 of the opposing sections 212, 214 of the blow mold 104, and accordingly produce a three-dimensional article having a shape generally conforming to the shape of the inner cavity 220 of the blow mold 104.
A temperature of the blow mold 104: the temperature of the blow mold 104 directly affects, among others, the cooling time/rate of the parison 114 at step 206 and that the temperature of the blow mold 104 should be selected in view of the physical properties of the plastic material (or plastic materials, as further described below) being blow molded.
A cooling time at step 206 of the blow molding process 200: the cooling time may be related to the temperature difference between the temperature of the parison 114 and the temperature of the inner walls 221, 223 of the opposing sections 212, 214 of the blow mold 104. In this context, the blow mold 104 is typically equipped with heating elements and the controller 222 may be used to define a set temperature of the inner walls 221, 223 of the opposing sections 212, 214 of the blow mold 104. In some non-limiting examples, a cooling medium such as liquid nitrogen, liquid carbon dioxide, etc. may also be injected into the inner cavity 220 of the blow mold 104 for further cooling.

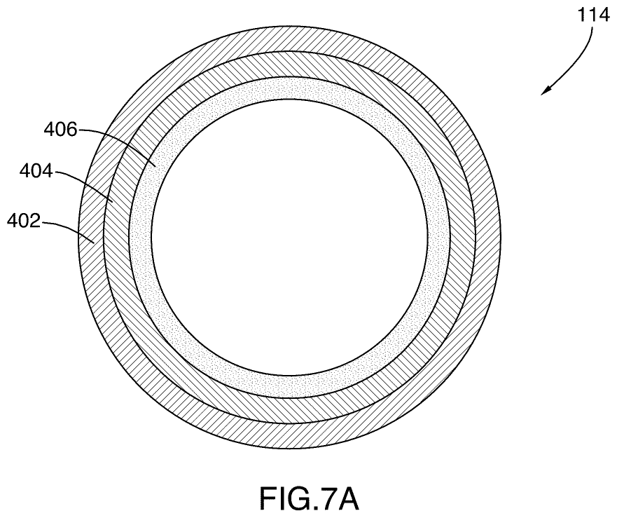

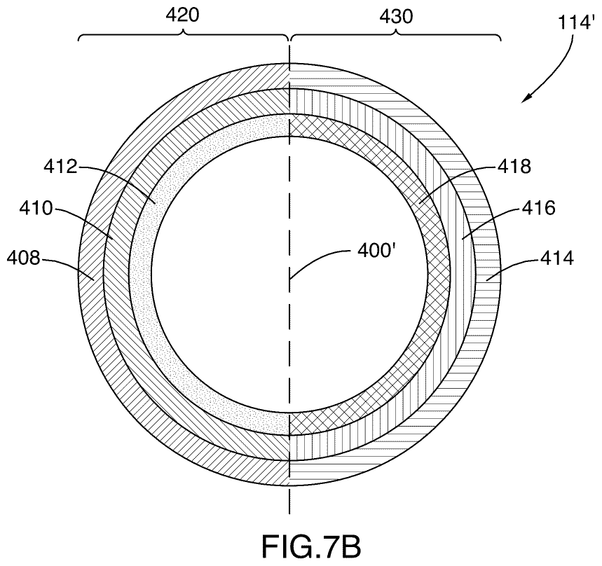

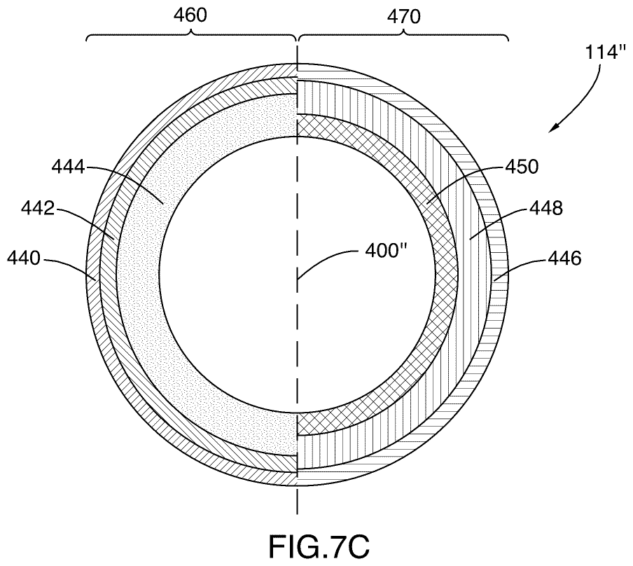

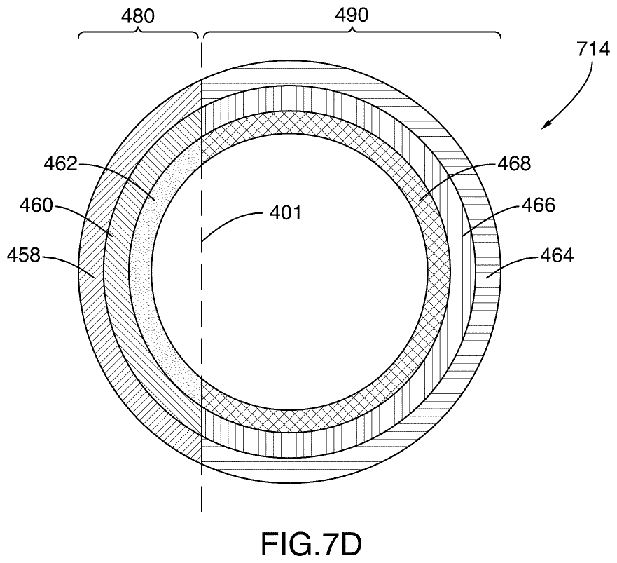

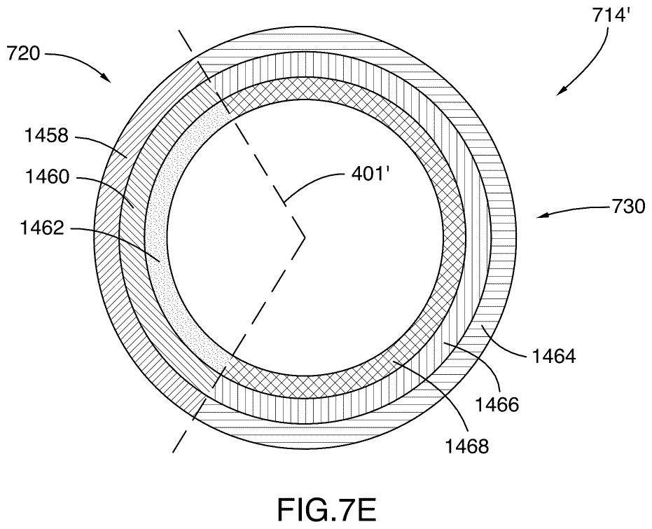

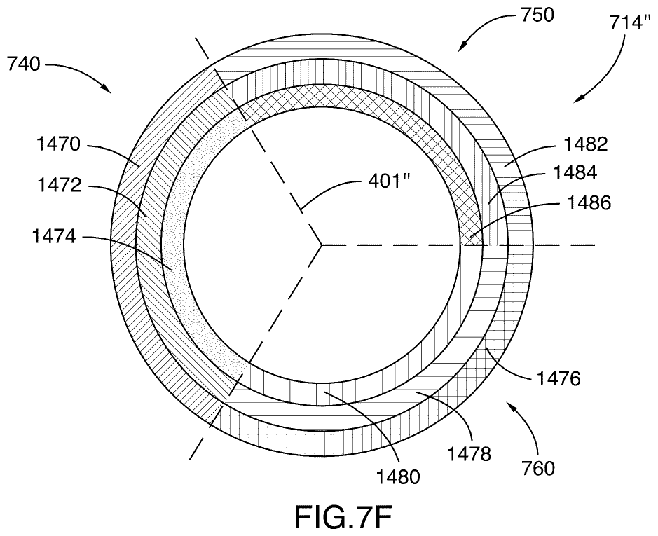

A cross-sectional view of a non-limiting embodiment of a parison 114 that can be produced using the system 100 is shown in FIG. 7A, the parison 114 having a three-layer structure with an outer layer 402, an inner layer 406 and an intermediate layer 404. Each one of the outer layer 402, the inner layer 406 and the intermediate layer 404 may have a color and/or a composition and/or mechanical properties that correspond to specific one of the regrind viscous plastic mixture 110; and the color viscous plastic mixture 111ⱼ released from the regrind extruder systems 106; and color extruder systems 107ⱼ, respectively. In some non-limiting examples, both the outer layer 402 and the inner layer 406 may have a color (which may or may not be the same) such that the outer and inner surfaces of the corresponding three-dimensional part or article produced from the parison 114 will exhibit the same color as the color of the corresponding layer 402/406 (which accordingly may or may not be the same). In a further non-limiting example, the intermediate layer 404 may be a regrind layer (i.e., the intermediate layer 404 may be made using a regrind viscous plastic mixture 110;), especially when it is adjacent the color outer and inner layers 402, 406, since the intermediate layer 404 will not be visible in the corresponding three-dimensional part or article produced from the parison 114. This latter configuration contributes to an increase in the economic efficiency of the process 200, the three-dimensional part or article produced by the process 200 being made in part from a regrind, while remaining visually and/or aesthetically pleasant to a user due to the presence of color in the outer and inner layers 402, 406.

In some non-limiting examples, the outer layer 402, the inner layer 406 and the intermediate layer 404 are made of the same thermoplastic material, however at least two of the outer layer 402, the inner layer 406 and the intermediate layer 404 have distinct colors. In further non-limiting examples, at least one of the outer layer 402, the inner layer 406 and the intermediate layer 404 is a regrind layer (i.e., at least one of the outer layer 402, the inner layer 406 and the intermediate layer 404 is made using the regrind viscous plastic mixture 110ᵢ released from the regrind extruder system 106ᵢ, and which may or may not have a color). Any suitable configuration of the layers 402, 404 and 406 of the parison 114 is possible in other non-limiting examples.

As described above, the layers of the parison 114, and ultimately the corresponding layers of the three-dimensional part or article produced therefrom, may or may not be formed of the same thermoplastic material. While any suitable combination of thermoplastic materials may be possible, it will be appreciated that forming a parison 114 having multiple layers of the same thermoplastic material will ensure that the three-dimensional part or article exhibits uniform rheological properties and easier processability.

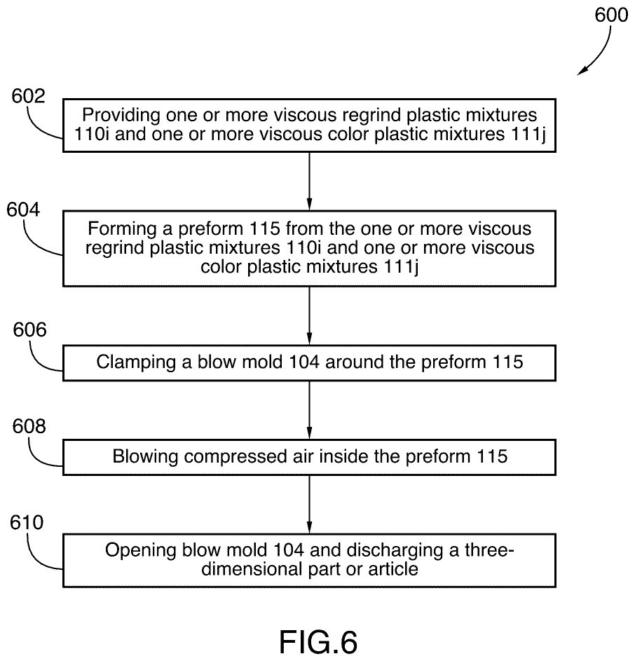

A cross-sectional view of another non-limiting embodiment of a parison 114′ is shown in FIG. 7B, the parison 114′ having a three-layer structure, the parison 114′ being further characterized by a parting line 400′ in a cross-section of the parison 114′. In this embodiment, the parting line 400′ is a line of separation of the parison 114′ into two (half) portions, a first (or top) portion 420 corresponding to the (top) outer layer 408, the (top) inner layer 412 and the (top) intermediate layer 410 and a second (or bottom) portion 430 corresponding to the (bottom) outer layer 414, the (bottom) inner layer 418 and the (bottom) intermediate layer 416. In some non-limiting examples, the parting line 400′ may be coextensive with a parting line in a cross section of the blow mold 104 (even though the parting line of the blow mold 104 is not shown in FIG. 6, it will be appreciated that such parting line would be coextensive with a plane of separation/boundary plane between the opposing sections 212, 214 of the blow mold 104, i.e., the region of the blow mold 104 where the two opposing sections 212, 214 of the blow mold 104 can be separated—or can be moved apart from each other—to permit the release of the three-dimensional part or article from the blow mold 104). In other non-limiting examples, the parting line 400′ may not be coextensive with the parting line in the cross section of the blow mold 104.

The first (or top) portion 420 of the parison 114′ may correspond to the top portion of the three-dimensional part or article produced therefrom, while the second (or bottom) portion 430 of the parison 114′ may correspond to the bottom portion of the three-dimensional part or article produced therefrom. In other words, in the non-limiting examples in which the parting line 400′ is coextensive with the parting line in the cross section of the blow mold 104 the top and bottom portions of the three-dimensional part or article exhibit a layered structure, specifically a three-layer structure, which may be different between the top portion and the bottom portion of the three-dimensional part or article (for example, in terms of the color and/or the composition and/or the mechanical properties of the top and bottom portions and the respective layers thereof). Any other suitable configuration and positioning of the parting line 400′ relative to the three-dimensional part or article produced from the parison 114′ may be possible in other embodiments (for example, the first portion 420 of the parison 114′ may correspond to the left portion of the three-dimensional part or article produced therefrom and the second portion 430 of the parison 114′ may correspond to the right portion of the three-dimensional part or article produced therefrom, the first portion 420 of the parison 114′ may correspond to the bottom portion of the three-dimensional part or article produced therefrom and the second portion 430 of the parison 114′ may correspond to the top portion of the three-dimensional part or article produced therefrom, etc.).

In the non-limiting embodiment of FIG. 7B, both the top outer layer 408 and the bottom outer layer 414 generally correspond to the top and bottom outer layers of the three-dimensional part or article produced by the process 200. Similarly, both the top inner layer 412 and the bottom inner layer 418 generally correspond to the top and bottom inner layers of the three-dimensional part or article produced by the process 200. In other words, each one of the regrind extruder systems 106; and the color extruder systems 107ⱼ may be used to produce separate one of a top/bottom layer of a three-dimensional part or article produced using the process 200. Each one of the outer layers 408/414, the inner layers 412/418 and the intermediate layers 410/416 may or may not have the same color and/or composition and/or mechanical properties.

In some non-limiting examples, the outer layers 408/414, the inner layers 412/418 and the intermediate layers 410/416 are made of the same thermoplastic material, however the outer layers 408/414, the inner layers 412/418 and the intermediate layers 410/416 have distinct colors. In further non-limiting examples, at least one of the outer layers 408/414, the inner layers 412/418 and the intermediate layers 410/416 is a regrind layer (i.e., at least one of the outer layers 408/414, the inner layers 412/418 and the intermediate layers 410/416 is made using a regrind viscous plastic mixture 110ᵢ, which may or may not have a color).

While in the non-limiting embodiments of FIGS. 7A and 7B the layers of the parison 114, 114′ have generally the same thickness (when measured along the cross section of the parison 114, 114′), it will be readily appreciated that this is not always the case as the various layers of the parison 114, 114′ may have different thicknesses, as further described below.

A cross-sectional view of a further non-limiting embodiment of a parison 114″ is shown in FIG. 7C, the parting line 400″ being a line of separation of the parison 114″ into two portions, a first (or top) portion 460 corresponding to the (top) outer layer 440, the (top) inner layer 444 and the (top) intermediate layer 442 and a second (or bottom) portion 470 corresponding to the (bottom) outer layer 446, the (bottom) inner layer 450 and the (bottom) intermediate layer 448. At least one of the top outer layer 440, the top inner layer 444, the top intermediate layer 442, the bottom outer layer 446, the bottom inner layer 450 and the bottom intermediate layer 448 has a greater thickness than the remaining (top and bottom) layers of the parison 114″ (and accordingly exhibits a greater volume/mass fraction than the remaining layers in the parison 114″). In some non-limiting examples, the volume/mass fraction of at least one of the top outer layer 440, the top inner layer 444, the top intermediate layer 442, the bottom outer layer 446, the bottom inner layer 450 and the bottom intermediate layer 448 is at least 10% more, in some cases at least 20% more, in some cases at least 25% more, in some cases at least 50% more, in some cases at least 75% more, in some cases at least 100% more, in some cases at least 125% more, in some cases at least 150% more than the volume/mass fraction of the remaining layers of the parison 114″, and in some cases even more. Any other suitable configuration of the parison 114″ may be possible into other embodiments.

In this non-limiting embodiment, the top inner layer 444 is thicker than the top outer layer 440 and the top intermediate layer 442. Similarly, in this non-limiting embodiment the bottom intermediate layer 448 is thicker than the bottom outer layer 446 and the bottom inner layer 450. In other words, the volume/mass fraction of each one of the top inner layer 444 and the bottom intermediate layer 448 in the parison 114″ is greater than the volume/mass fraction of each one of the top outer layer 440, the top intermediate layer 442, the bottom outer layer 446 and the bottom inner layer 450. In some non-limiting examples, the volume/mass fraction of each one of the top inner layer 444 and the bottom intermediate layer 448 in the parison 114″ is at least 10% more, in some cases at least 20% more, in some cases at least 25% more, in some cases at least 50% more, in some cases at least 75% more, in some cases at least 100% more, in some cases at least 125% more, in some cases at least 150% more than the volume/mass fraction of each one of the top outer layer 440, the top intermediate layer 442, the bottom outer layer 446 and the bottom inner layer 450, and in some cases even more.

In some non-limiting examples, the top inner layer 444 and the bottom intermediate layer 448 are regrind layers (i.e., the top inner layer 444 and the bottom intermediate layer 448 are each made using a regrind viscous plastic mixture 110; which may or may not have a color) and the top outer layer 440, the top intermediate layer 442, the bottom outer layer 446 and the bottom inner layer 450 each have a color. This configuration may contribute to an increase in the economic efficiency of the process 200, the three-dimensional part or article produced from the parison 114″ being made in part from a regrind while remaining visually and/or aesthetically pleasant to a user due to the presence of color in the top outer layer 440, the top intermediate layer 442, the bottom outer layer 446 and the bottom inner layer 450, and which include at least some layers of the three-dimensional part or article produced by the process 200 that may be visible to the user during use of the three-dimensional part or article. It will also be appreciated that, by relying on regrind layers as the top inner layer 444 and the bottom intermediate layer 448, at least 25%, in some cases at least 40%, in some cases at least 50%, in some cases at least 60%, in some cases at least 75% of the volume/mass fraction of the three-dimensional part or article may be made of regrind (i.e., any suitable recycled resin, for example the blow molded trimmings 105), and in some cases even more. This contributes to an increase in the economic efficiency of the process 200.

The thickness of respective ones of the layers of the parison 114″ of FIG. 7C may be controlled via the control of the flow rate of the corresponding viscous plastic mixture.

In addition, and with further reference to FIG. 7D, the parting line need not be centered relative to the parison and can be offset relative to a centerline of the parison. In the non-limiting embodiment of FIG. 7D, the parting line 401 is offset relative to a centerline of the parison 714 such that the parting line 401 separates the parison 714 into a first multi-layer portion 480 and a second multi-layer portion 490, the second portion 490 generally corresponding to a greater volume/mass fraction of the parison 714 than the first portion 480. The first multi-layer portion 480 corresponds to an outer layer 458, an inner layer 462 and an intermediate layer 460 and the second multi-layer portion 490 corresponds to an outer layer 464, an inner layer 468 and an intermediate layer 466. In some non-limiting examples, the volume/mass fraction of the second portion 490 in the parison 714 is at least about 60%, in some cases at least about 65%, in some cases at least about 70%, in some cases at least about 75%, in some cases at least about 80%, in some cases at least about 85% and in some cases even more.

Each one of the regrind extruder systems 106; and the color extruder systems 107ⱼ may be used to produce individual ones of the outer layers 458/464, the inner layers 462/468 and the intermediate layers 460/466, and which may or may not have the same color and/or composition and/or mechanical properties.

In further non-limiting embodiments, and with further reference to FIG. 7E, the parting line need not separate the parison into two equal “halves”. More specifically, in the non-limiting embodiments of FIGS. 7B-7D, the parisons 114′/114″/714 have a “180°-180° configuration” (i.e., an angle of 180° can be defined on either side of the corresponding parting lines 400′/400″/401—it will be appreciated that the sum of the individual angular portions defined around the parting line must be equal to) 360°. As shown in FIG. 7E, the parison 714′ has a 120°-240° configuration (i.e., an angle of 120° can be defined on one side of the parting line 401′, and an angle of 240° can be defined on the other side of the parting line 401′), which accordingly defines a first multi-layer portion 720 corresponding to an outer layer 1458, an inner layer 1462 and an intermediate layer 1460 and a second multi-layer portion 730 corresponding to an outer layer 1464, an inner layer 1468 and an intermediate layer 1466. It will be readily appreciated that any suitable configuration of the parison 714′ may be used in other non-limiting examples, such as but not limited to a 170°-190° configuration, a 160°-200° configuration, a 150°-210° configuration, a 140°-220° configuration, a 130°-230° configuration, a 120°-240° configuration, a 110°-250° configuration, a 100°-260° configuration, a 90°-270° configuration, a 80°-280° configuration, a 70°-290° configuration and a 60°-300° configuration. Accordingly, in this non-limiting example a volume/mass fraction of the first section 720 in the parison 714′ is less than about 50%, in some cases less than about 45%, in some cases less than about 40%, in some cases less than about 35% in some cases less than about 30%, in some cases less than about 25% and in some cases even less.

Each one of the regrind extruder systems 106; and the color extruder systems 107ⱼ may be used to produce individual ones of the outer layers 1458/1464, the inner layers 1462/1468 and the intermediate layers 1460/1466, and which may or may not have the same color and/or composition and/or mechanical properties and/or thickness.

In yet further non-limiting examples, and with further reference to FIG. 7F, the parting line need not separate the parison into two portions. In the non-limiting examples of FIGS. 7B-7E, the parisons 114′/114″/714/714′ comprise two portions, where one of the two portions may or may not correspond to a greater volume/mass fraction of the parison relative to the other. As shown in FIG. 7F, the parting line 401″ separates the parison 714″ into three multi-layer portions 740, 750 and 760. The first multi-layer portion 740 corresponds to an outer layer 1470, an inner layer 1474 and an intermediate layer 1472, the second multi-layer portion 750 corresponds to an outer layer 1476, an inner layer 1480 and an intermediate layer 1478, and the third multi-layer portion 750 corresponds to an outer layer 1482, an inner layer 1486 and an intermediate layer 1484. The parison 714″ has a 120°/120°/120° configuration (i.e., three angles of 120° can be defined around the parting line—it will be appreciated that the sum of the individual angular portions defined around the parting line must be equal to) 360°. As shown in FIG. 7F, the parison 714″ has a 120°-120°-120° configuration (i.e., 3 angles of 120° can be defined around the parting line 401″), which accordingly defines a first multi-layer portion 740, a second multi-layer portion 750 and a third multi-layer portion 760. It will be readily appreciated that any suitable configuration of the parison 714″ may be used in other non-limiting examples (i.e., any possible permutation of 3 angles around the parting line 401″ whose sum equals 360° and, accordingly, any permutation of volume/mass fraction of respective ones of the first, second and third multi-layer portions 740, 750 and 760 within the parison 714″).

Each one of the regrind extruder systems 106; and the color extruder systems 107ⱼ may be used to produce individual ones of the outer layers 1470/1476/1482, the inner layers 1474/1480/1486 and the intermediate layers 1472/1478/1484, and which may or may not have the same color and/or composition and/or mechanical properties and/or thickness.

Although FIGS. 7A-7F show various embodiments of a parison with a multilayered structure (more specifically, 3 layers in FIG. 7A, 2 portions each with 3 layers in FIGS. 7B-7E and 3 portions each with 3 layers in FIG. 7F), it will be readily appreciated that any other suitable number of layers and portions of the parison may be suitable in other non-limiting embodiments (e.g., 2-layer structures, 4-layer structures and the likes). It will also be appreciated that the thickness of the layers of the parisons 714, 714′ and 714″ in FIGS. 7D-7F needs not be the same.

Of note, in the multi-layer configuration of the parisons 114, 114′, 114″, 714, 714′ and 714″, each one of the individual layers of the parison 114 exhibits well-defined boundaries without any blending or mixing of material between adjacent ones of the layers. This enables each one of the individual layers to retain its mechanical properties and/or composition and/or color within respective ones of the parisons 114, 114′, 114″, 714, 714′ and 714″.

With further reference to FIG. 1B, a non-limiting embodiment of a system 100′ for manufacturing a three-dimensional part or article using an injection blow molding process is shown. The system 100′ shares many similarities with the system 100 of FIG. 1A as the system 100′ also comprises one or more regrind extruder systems 106; and one or more color extruder systems 107ⱼ which release the regrind viscous plastic mixture 110; and the color viscous plastic mixtures 111ⱼ, respectively, towards the feedblock 103. The feedblock 103 in turn releases the viscous layered stream 112 towards a preform mold 113. There is accordingly no die 102/no (optional) accumulator 109 in the system 100′.

The preform mold 113 comprises a cavity and a core pin (not shown), the viscous layered stream 112 being accumulated inside the cavity to be injection molded into a preform 115 as the core pin is pushed against the viscous layered stream 112 to provide the desired shape of the preform 115. Contrary to the parison 114, which is a generally hollow cylindrical tube being accordingly open at both ends, the preform 115 is only open at one end.

The preform mold 113 is subsequently opened and the preform 115 is rotated and directed towards the blow mold 104 to form the three-dimensional part or article.

A non-limiting embodiment of an injection blow molding process 600 implementable by the system 100′ is described below in connection with FIG. 6.

In a first step 602, one or more regrind viscous plastic mixtures 110; and one or more color viscous plastic mixtures 111ⱼ mixtures are provided.

In a second step 604, the one or more regrind viscous plastic mixtures 110; and the one or more color viscous plastic mixtures 111ⱼ are caused to flow inside the preform mold 113 to form the preform 115 having the shape of a generally hollow cylinder, the preform 115 being opened only at one end as a result of the operation of the core pin with the preform mold 113.

In a third step 606, the opposing sections 212, 214 of the blow mold 104 are clamped around the preform 115 and in a fourth step 608, compressed air is blown from inside of the preform 115 into the inner cavity 220 of the blow mold 104. As a result of the pressure build-up inside the preform 115, the preform 115 is inflated, thereby forcing the preform 115 against the inner walls 221, 223 of the opposing sections 212, 214 of the blow mold 104. At the fourth step 608, the preform 115 is accordingly shaped into a form generally conforming to the shape of the inner cavity 220 of the blow mold 104 (i.e., the shape of the three-dimensional part article to be blow molded using the process 600).

In a fifth step 610, once the preform 115 has sufficiently cooled as a result of the introduction of compressed air and of the contact with the inner walls 221, 223 of the blow mold 104, the blow mold 104 is opened and the three-dimensional article is discharged from the blow mold 104. The three-dimensional article may then be trimmed (for example, to remove sections of the preform 115 that remained outside the inner cavity 220 of the blow mold 104 during steps 606 and 608).

In a non-limiting embodiment, the system 100′ is generally configured such that the performing of the blow molding process 600 results in the formation of a preform 115 having a layered structure across a cross-section of the preform 115, each one of the layers of the preform 115 being derived exclusively from one of the regrind viscous plastic mixtures 110ᵢ/the color viscous plastic mixtures 111ⱼ released by the regrind extruder systems 106ᵢ/color extruder systems 107ⱼ, respectively. In other words, the color and/or the composition and/or the mechanical properties of each one of the layers of the preform 115 may be associated with specific one of the regrind viscous plastic mixtures 110ᵢ/the color viscous plastic mixtures 111ⱼ produced by the system 100′. The system 100′ therefore enables one to individually control the color and/or the composition and/or the mechanical properties of each one of the layers of the preform 115. The three-dimensional part or article that is made from the preform 115 using the system 100′/the process 600 also embodies the layered structure of the preform 115. It will be readily appreciated that the preform 115 (and, accordingly, the three-dimensional part or article that is produced therefrom) may have any suitable number and configuration of layers.

Although the parison 114 and the preform 115 are each formed/molded by distinct blow molding processes, the principles described above in connection with the parisons 114, 114′, 114″, 714, 714′, 714″ (and, accordingly, in connection with extrusion blow molding processes such as the process 200, including continuous extrusion blow molding processes and intermittent extrusion blow molding processes) are also applicable to the preform 115 which is formed in injection blow molding processes. Specifically, the preform 115 may exhibit any of the characteristics described above in connection with the parisons 114, 114′, 114″, 714, 714′, 714″, including in terms of the number of layers of the preform 115, the thickness of the layers of the preform 115 and the configuration of the parting line of the preform 115.

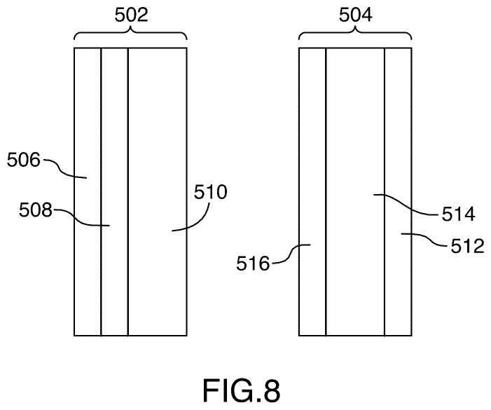

As further described below, as a result of the presence of the regrind viscous plastic mixtures 110; and color viscous plastic mixtures 111ⱼ released by each one of the regrind extruder systems 106; and color extruder systems 107ⱼ, respectively, and accordingly as a result of the layered configuration of the parisons 114, 114′, 114″, 714, 714′, 714″, the three-dimensional part or article produced by the system 100/process 200, or the system 100′/process 600 also exhibits a multilayered structure (along a cross-section of the three-dimensional part article). FIG. 8 shows a schematic representation of two multilayered portions, a top portion 502 and a bottom portion 504, in a cross-section of a three-dimensional part or article produced from the parison 114″ of FIG. 7C. Specifically, the top portion 502 comprises an outer layer 506, intermediate layer 508 and an inner layer 510, the outer layer 506, the intermediate layer 508 and the inner layer 510 corresponding to the top outer layer 440, the top intermediate layer 442 and the top inner layer 444 of the parison 114″, respectively. The bottom portion 504 comprises an outer layer 512, an intermediate layer 514 and an inner layer 516, the outer layer 512, the intermediate layer 514 and the inner layer 516 corresponding to the bottom outer layer 446, the bottom intermediate layer 448 and the bottom inner layer 450 of the parison 114″, respectively. In other words, each one of the one or more regrind extruder systems 106; and the one or more color extruder systems 107ⱼ may be used to produce distinct one of the (top) outer layer 506, the (top) intermediate layer 508, the (top) inner layer 510, the (bottom) outer layer 512, the (bottom) intermediate layer 514 and the (bottom) inner layer 516 using the process 200/the system 100. The color and/or composition and/or mechanical properties of each one of the (top) outer layer 506, the (top) intermediate layer 508, the (top) inner layer 510, the (bottom) outer layer 512, the (bottom) intermediate layer 514 and the (bottom) inner layer 516 may accordingly be selected using the system 100/the process 200.

Where the parison comprises more than one portion each having a layered structure, for example the first and second portions 420, 430 of the parison 114′, the first and second portions 460, 470 of the parison 114″, the first and second portions 480, 490 of the parison 714, or the first and second portions 720, 730 of the parison 714′, it will be readily appreciated that each one of the portions may be associated with regions of the three-dimensional part or article produced from the parison 114′, 114″, 714 or 714′ having different functionalities. In some non-limiting examples, the three-dimensional product may be a kayak in which case the first (or top) portion 460 of the parison 114″ is generally associated with a deck portion of the kayak (which is configured to receive a user), while the second (or bottom) portion 470 of the parison 114″ is generally associated with a hull portion of the kayak (which is configured to engage water).

In this non-limiting embodiment, the layers 506, 508 and 510 of the top portion 502 of the three-dimensional part or article may each represent a predetermined weight and/or volume fraction of the top portion 502. In some non-limiting examples, a weight fraction of one of the layers 506, 508 and 510 in the top portion 502 may be about 10%, in some cases about 20%, in some cases about 25%, in some cases about 30%, in some cases about 35%, in some cases about 40%, in some cases about 45%, in some cases about 50%, in some cases about 55%, in some cases about 60%, in some cases about 65% and in some cases even more. Similarly, In some non-limiting examples, a volume fraction of one of the layers 506, 508 and 510 in the top portion 502 may be about 10%, in some cases about 20%, in some cases about 25%, in some cases about 30%, in some cases about 35%, in some cases about 40%, in some cases about 45%, in some cases about 50%, in some cases about 55%, in some cases about 60%, in some cases about 65% and in some cases even more.

Similarly, the layers 512, 514 and 516 of the bottom portion 504 may each represent a predetermined weight and/or volume fraction of the bottom portion 504. In yet further non-limiting examples, a weight fraction of one of the layers 512, 514 and 516 in the bottom portion 504 may be about 10%, in some cases about 20%, in some cases about 25%, in some cases about 30%, in some cases about 35%, in some cases about 40%, in some cases about 45%, in some cases about 50%, in some cases about 55%, in some cases about 60%, in some cases about 65% and in some cases even more. Similarly, in some non-limiting examples, a volume fraction of one of the layers 512, 514 and 516 in the bottom portion 504 may be about 10%, in some cases about 20%, in some cases about 25%, in some cases about 30%, in some cases about 35%, in some cases about 40%, in some cases about 45%, in some cases about 50%, in some cases about 55%, in some cases about 60%, in some cases about 65% and in some cases even more.

The volume and/or weight fractions of the layers 506, 508 and 510 in the top portion 502 may be the same or they may be different. For example, the volume and/or weight fraction of the inner layer 510 in the top portion 502 may be about 50%, and the volume and/or weight fraction of each one of the intermediate layer 508 and the outer layer 506 in the top portion 502 may be about 25%.

Similarly, the volume and/or weight fractions of the layers 512, 514 and 516 in the bottom portion 504 may be the same or may be different. For example, the volume and/or weight fraction of the intermediate layer 514 in the bottom portion 504 may be about 50%, and the volume and/or weight fraction of each one of the inner layer 516 and the outer layer 512 in the bottom portion 504 may be about 25%.

It will be readily appreciated that any other suitable configuration (in terms of respective volume and/or weight fractions) of the layers 506, 508, 510, 512, 514 and 516 may be possible in other non-limiting examples and that such configurations can be obtained in any three-dimensional part or article produced by the system 100/process 200 or by the system 100′/process 600.

Beyond variations in the volume and/or weight fraction of the layers 506, 508, 510, 512, 514 and 516 in respective ones of the top and bottom portions 502, 504, the layers 506, 508, 510, 512, 514 and 516 may or may not have the same composition, viscosity, color, virgin/regrind characteristics and any suitable combination of composition, viscosity color, virgin/regrind characteristics for the layers 506, 508, 510, 512, 514 and 516 may be used. For example, when the intermediate layer 514 of the bottom portion 504 is a regrind layer, it may be advantageous to increase the volume and/or weight fraction of the intermediate layer 514 in the bottom portion 504 to increase the volume and/or weight fraction of recycled material in the bottom portion 504. Similarly, when the inner layer 506 of the top portion 502 is a regrind layer, it may be advantageous to increase the volume and/or weight fraction of the inner layer 506 in the top portion 502 to increase the volume and/or weight fraction of recycled material in the top portion 502. It is understood that other characteristics may be chosen for one or more of the layers 506, 508, 510, 512, 514 and 516, including but not limited to rigidity, resilience, resistance to stress, resistance to tension, resistance to water, barrier properties, porosity, hardness, crumpling, melting and/or glass transition temperatures, malleability and other characteristics. Suitable materials may be chosen for forming said layers according to the desired characteristics and extruded as described above without departing from the present teachings.

In this embodiment, the three-dimensional article 500 produced by the process 200 has a multilayered structure, specifically a 3-layer structure, and the 3-layer structure of the three-dimensional article 500 may or may not be different between the top and bottom portions 502, 504 of the three-dimensional article 500.

The three-dimensional article 500 may be any suitable article formed by a blow molding process (including continuous extrusion blow molding processes, intermittent extrusion blow molding processes, injection blow molding processes, etc.). In some non-limiting examples, the three-dimensional article 500 may be a kayak and the top and bottom portions 502, 504 may generally correspond to the deck and the hull portions of the kayak, respectively.

It will be readily appreciated that a variety of parts and articles covering the whole spectrum of blow molding applications such as packaging, automotive & transportation, consumables & electronics and building & construction may be produced using a process/system embodying at least some aspects of the present disclosure including, but not limited to, discontinuous, multi-segmented, multi-material products (including long or low-viscosity products) such as kayaks, boats, surfboards, paddleboards, shed walls, portable toilets, hunting blinds and the likes.

### Exemplary Configuration of the System 100

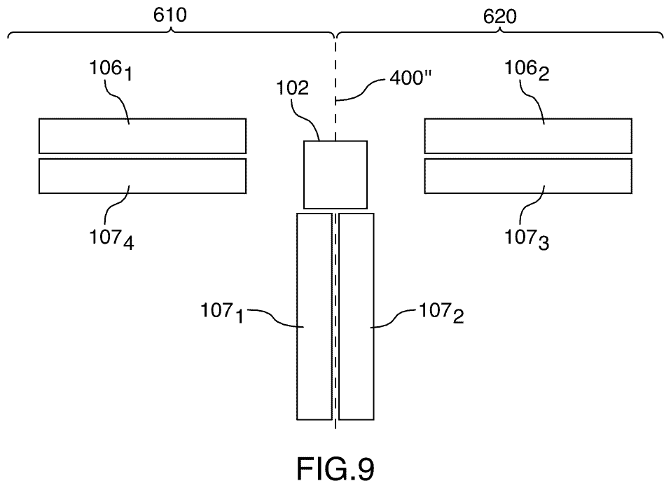

FIG. 9 shows a non-limiting embodiment of a configuration of the system 100 for the production of the parison 114″. Specifically, the system 100 comprises 4 color extruder systems 107₁, 107₂, 107₃ and 107₄ as well as 2 regrind extruder systems 106₁ and 106₂.

As shown in FIG. 9, the various extruder systems can be conceptually grouped into two groups 610, 620 according to their position relative to the die 102/parting line 400″. In other words, in this non-limiting embodiment the first group 610 which comprises the color extruder system 107₄, the color extruder system 107₁ and the regrind extruder system 106₁ is used to produce the first (i.e., a top) portion 460 of the parison 114″, while the second group 620 which comprises the color extruder systems 107₂, 107₃ and the regrind extruder system 106₂ is used to produce the second (i.e., bottom) portion 470 of the parison 114″.

More specifically, in this non-limiting embodiment, the configuration of the first group 610 and the second group 620 relative to the die 102/parting line is as follows:
The top outer layer 440 of the parison 114″ is derived from the color viscous plastic mixture released by the color extruder system 107₄;
The top intermediate layer 442 of the parison 114″ is derived from the color viscous plastic mixture released by the color extruder system 107₁;
The top inner layer 444 of the parison 114″ is derived from the regrind viscous plastic mixture released by the regrind extruder system 106₁;
The bottom outer layer 446 of the parison 114″ is derived from the color viscous plastic mixture released by the color extruder system 107₂;
The bottom intermediate layer 448 of the parison 114″ is derived from the regrind viscous plastic mixture released by the regrind extruder system 106₁; and
The bottom inner layer 450 of the parison 114″ is derived from the color viscous plastic mixture released by the color extruder system 107₃.

It will be readily appreciated that any other suitable configuration of the system 100, more specifically of the groups 610 and 620 may be possible in other non-limiting embodiments.

The embodiments described above are intended to be exemplary only. The scope of the present disclosure is therefore intended to be limited solely by the appended claims.

1. A system for blow-molding a three-dimensional article, the system comprising:
at least two regrind extruder systems, each one of the at least two regrind extruder systems being configured to release a regrind viscous mixture;
at least two color extruder systems, each one of the at least two color extruder systems being configured to release a color viscous mixture;
a feedblock configured to receive and combine the at least two regrind viscous mixtures and the at least two color viscous mixtures into a layered stream;
a forming system for forming a cylindrical blank from the layered stream, the cylindrical blank comprising two circumferential portions, each one of the two circumferential portions having a layered configuration characterized by at least two layers across a cross-section of the cylindrical blank; and
a blow mold configured to receive the cylindrical blank, wherein the cylindrical blank is inflated inside the blow mold to form the three-dimensional article,
wherein each one of the at least two layers of the two circumferential portions of the cylindrical blank is formed by one of the at least two regrind viscous mixtures and the at least two color viscous mixtures.

2. The system of claim 1, wherein the forming system comprises a die.

3. The system of claim 2, wherein the die is configured to extrude the cylindrical blank continuously.

4. The system of claim 1, wherein the forming system comprises an accumulator and a die.

5. The system of claim 4, wherein the accumulator and the die are configured to extrude the cylindrical blank intermittently.

6. The system of claim 2, wherein the cylindrical blank is a parison.

7. The system of claim 1, wherein the forming system comprises a preform mold.

8. The system of claim 7, wherein the cylindrical blank is a preform.

9. The system of claim 1, wherein each one of the two circumferential portions has three layers across the cross-section of the cylindrical blank.

10. The system of claim 1, wherein at least one of the at least two layers of the two circumferential portions has a thickness different from remaining ones of the layers of the two circumferential portions.

11. The system of claim 1, wherein the at least two regrind viscous mixtures and the at least two color viscous mixtures are thermoplastic mixtures.

12. The system of claim 11, wherein the thermoplastic mixtures comprise one of low-density polyethylene (LDPE) mixtures, high-density polyethylene (HDPE) mixtures, polyethylene terephthalate (PET) mixtures, acrylonitrile butadiene styrene (ABS) mixtures, polystyrene mixtures, polypropylene (PP) mixtures, acetate mixtures, butyrate mixtures, nylon mixtures, polyphenylene sulfide mixtures, acetal mixtures, polycarbonate mixtures, thermoplastic rubber mixtures and polyester mixtures.

13. The system of claim 1, wherein the three-dimensional article is a kayak having a deck portion and a hull portion.

14. The system of claim 13, wherein a first one of the two circumferential portions of the cylindrical blank corresponds to the deck portion, and a second one of the two circumferential portions of the cylindrical blank corresponds to the hull portion.

15. A system for blow-molding a three-dimensional article, the system comprising:
two regrind extruder systems, each one of the two regrind extruder systems being configured to release a regrind viscous mixture;
four color extruder systems, each one of the four color extruder systems being configured to release a color viscous mixture;
a die for forming a parison from the two regrind viscous mixtures and the four color viscous mixtures, the parison comprising a first portion and a second portion across a circumference of the parison, wherein each one of the first and the second portions of the parison has a 3-layer configuration across a cross-sectional profile, wherein each one of the layers of the first and the second portions is formed by one of the two regrind viscous mixtures and the four color viscous mixtures; and
a blow mold configured to receive the parison,
wherein the parison is inflated inside the blow mold to form the three-dimensional article.

16. The system of claim 15, wherein the first portion and the second portion each comprises an inner layer, a middle layer and an outer layer.

17. The system of claim 16, wherein, in the first portion, the inner layer constitutes at least about 50% by weight or by volume of the first portion.

18. The system of claim 16, wherein in the second portion, the intermediate layer constitutes at least about 50% by weight or by volume of the second portion.

19. The system of claim 15, wherein the three-dimensional article is a kayak having a deck portion and a hull portion.

20. The system of claim 19, wherein the first portion corresponds to the deck portion and the second portion corresponds to the hull portion.
